(19) United States
(12) Patent Application Publication
(10) Pub. No.: US 2018/0306403 A1
(43) Pub. Date: Oct. 25, 2018

(54) FESTIVE LIGHT KIT

(71) Applicant: Glen Bover, North Haledon, NJ (US)

(72) Inventor: Glen Bover, North Haledon, NJ (US)

(21) Appl. No.: 15/962,315

(22) Filed: Apr. 25, 2018

Related U.S. Application Data
(60) Provisional application No. 62/489,633, filed on Apr. 25, 2017.

(51) Int. Cl. F21V 3/02; F21V 17/06; F21V 17/16

(52) U.S. Cl. CPC F21V 3/02; F21W 2121/00; F21V 17/16; F21V 17/06

(57) ABSTRACT

A device adapted to generally surround and exterior lighting fixture to allow for customization of the fixture for various holiday's and occasions. The device comprised of a shell portion, a top portion, a fastener, and a gasket member in an assembly and configured for placement on a pole portion of the exterior fixture. The shell portion comprised of a first half and second half and secured together through the top portion. The gasket member enables a secure connection and establishes a generally weather tight seal.

### CROSS REFERENCE TO RELATED APPLICATIONS

This application claims priority to U.S. Provisional Patent Application No. 62/489,633 filed 25 Apr. 2017 to the above named inventor, and is herein incorporated by reference in its entirety.

### FIELD OF THE INVENTION

The invention relates generally to a festive light solution generally adapted for universal usage on outdoor landscape-styled lighting fixtures.

### BACKGROUND

Currently there are a number of solutions for outdoor festive lighting in the form of specific lighting elements and features. These solutions attempt to decorate for specific occasions though these separate lighting elements, but fail to meet the needs of the market because users have to purchase many different types of decorative lighting fixtures, which include lights, stakes for installation, separate lighted features, and sometimes separate power sources.

Therefore, there is a need for a universal lighting solution that easily allows a user to customize their current and traditional light fixtures with design elements for various festive occasions. Preferably this solution is easily placed onto and removed from existing lighting fixtures, is weather resistant, and durable.

### SUMMARY OF THE INVENTION

The apparatus of the present disclosure makes holiday and occasional light applications fun and festive by allowing a user to adapt existing light fixtures for various occasions. The apparatus of the present invention is generally a decorative device adapted for receipt on the stem portion of existing outdoor lighting fixtures, such as landscape pathway lights, for encircling the lighting portion and resulting in an illumination of the device of the present disclosure. The stem portion of these outdoor lighting fixtures is generally a tubular pole to allow for the wiring and accordingly has a circumference.

In a first embodiment of the device of the present disclosure, the device is comprised of a shell portion, a top portion, a fastener, and a gasket member provided in an assembly for generally surrounding a light source of a lighting fixture. Accordingly, the shell portion is constructed in an assembly from a pair of halves in the form of a first half mated to a second half in an adjacent assembly. The top portion is adapted to secure the first half to the second half and generally surrounding the perimeter of the mated shell halves. The fastener generally positioned on a lower portion of the shell portion to encircle the lower portion and provide a means for compression to the lower portion of the assembly for securing the device on the light fixture. The fastener preferably being a clip like member with a hinge adapted for opening and closing for removal and placement during use. The gasket member adapted to aid in securing the device to the circumference of the pole and comprised of a resilient material to seal the assembly. The gasket member comprised of a pair of halves secured to the pole at a desired height and generally including ribs on an interior side and ridges on an exterior side in a cooperative coupling with the lower portion to seat the shell portion in a secure assembly.

In an alternate embodiment the gasket member is directly integrated into the lower portion of the shell portion wherein the gasket is coupled to the securing means.

In an alternate embodiment the fastener is zip tie like member providing a means for selective compression of the securing of the device around the pole of the light fixture the device is placed upon.

The device of the present invention is preferably constructed of translucent shell portions and comprised of plastic material that is selected for its resiliency, durability, and ability to withstand extreme temperatures and heat from the light source and may be formed through various molding processes, including, but not limited to, injection molding, blow molding, thermoforming, and overmolding.

Furthermore, it would also be advantageous to have an apparatus that is practical.

Still further, it would be advantageous to have an apparatus that works universally with existing lighting sources.

The device is a way to leverage existing pathway or landscape lighting with decorative features and eliminates the need for additional power sources, light bulbs and stake/pole installations.

The device can be adapted in a multitude of different design options and colors to accommodate a variety of festive occasions and holidays.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows an exploded view of the device, according to the present invention;

FIG. 2 shows an exploded view of a portion of the device, according to the present invention;

FIG. 3 shows an exploded view of the shell portion of the device, according to the present invention;

FIG. 4 shows a cross sectional view of the assembly of the device, according to the present invention;

FIG. 5 shows an assembly of the gasket member of the device, according to the present invention;

FIG. 6 shows an assembly of the top portion of the device onto the shell portion of the device, according to the present invention;

FIG. 7 shows an exploded view of the assembly of the top portion of the device onto the shell portion of the device, according to the present invention;

FIG. 8 shows a perspective view of the fastener of the device, according to the present invention; and

FIG. 9 shows a side view of an alternate embodiment of the gasket member of the device, according to the present invention;

### DETAILED DESCRIPTION OF THE INVENTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful, and is not intended to exclude other embodiments from the scope of the invention.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The apparatus of the present disclosure is directed to be a decorative addition to existing outdoor lighting to allow for seasonal and occasion customization.

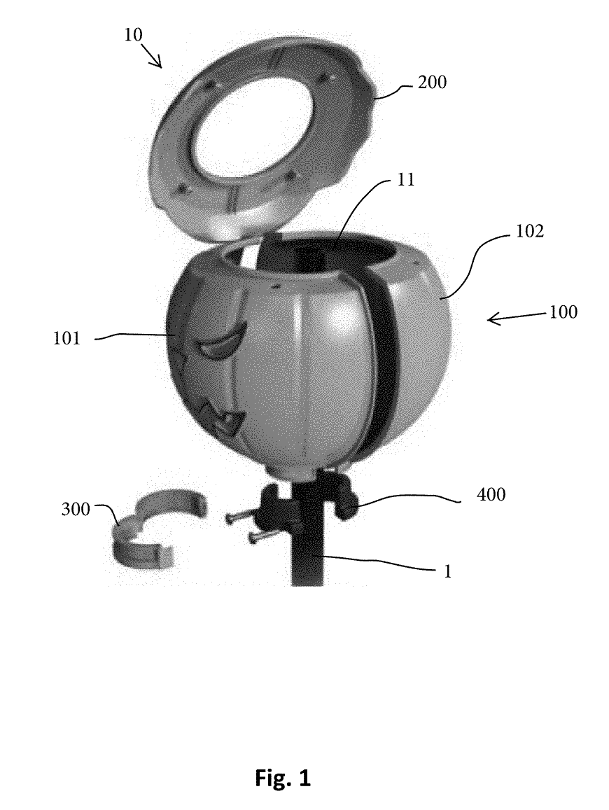

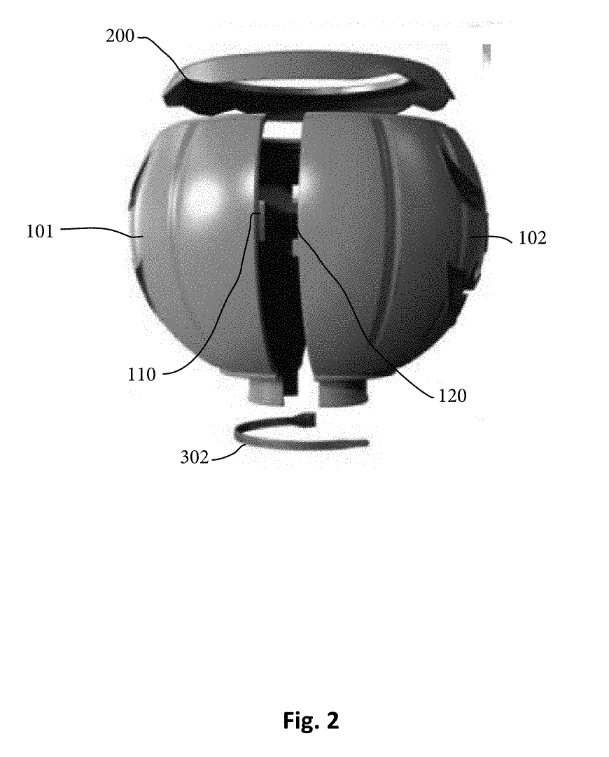

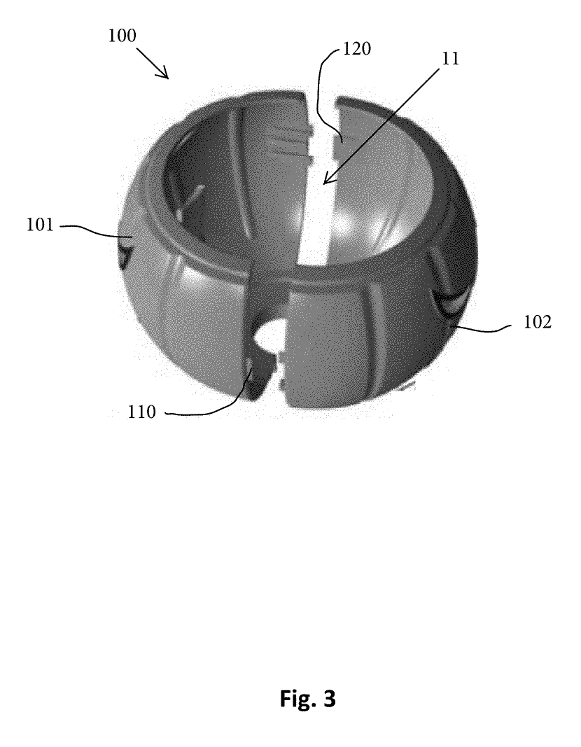

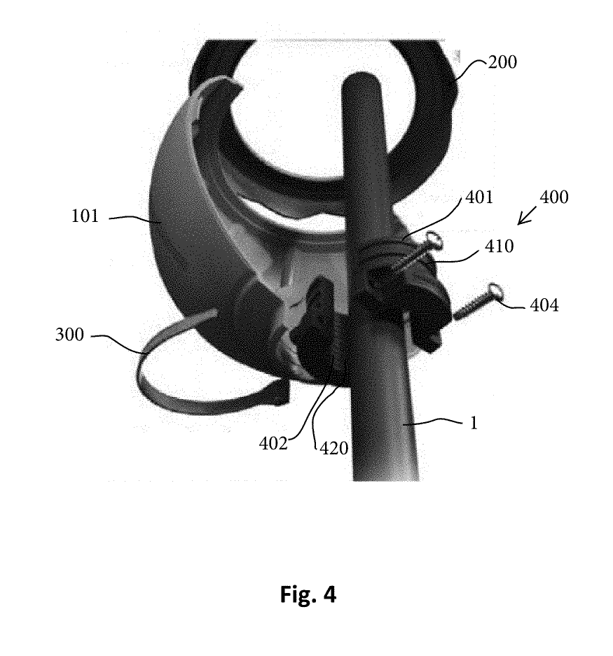

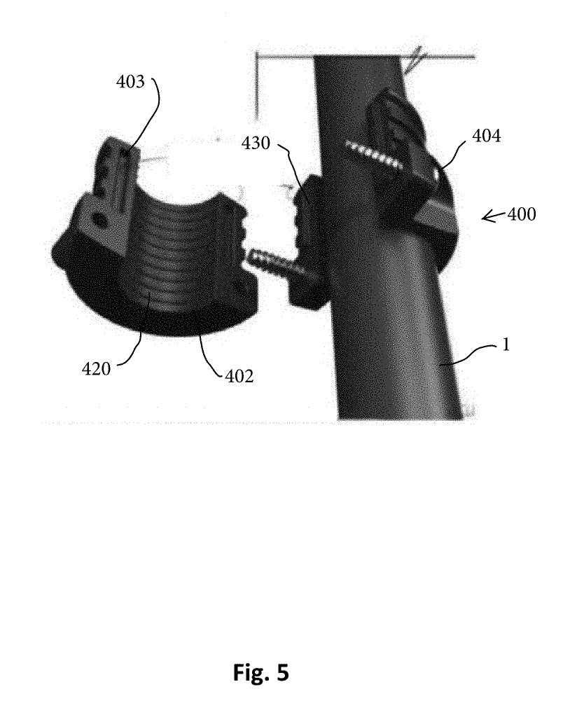

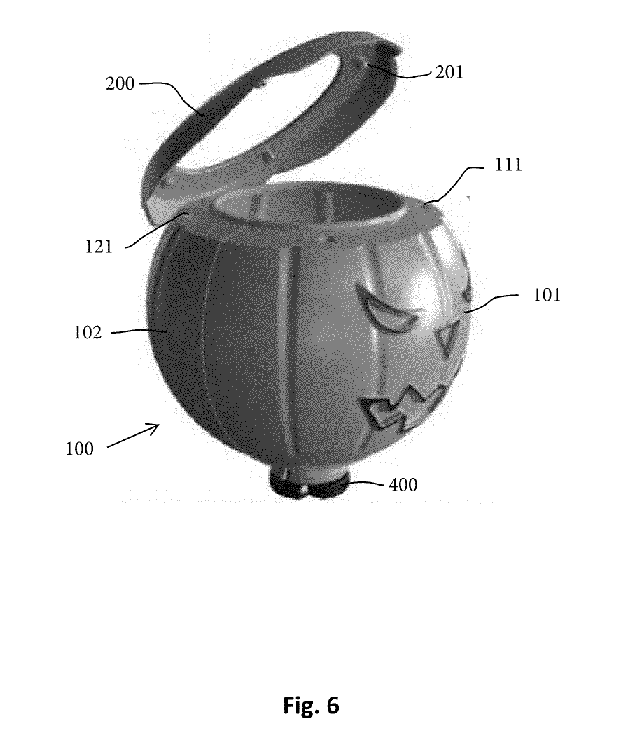

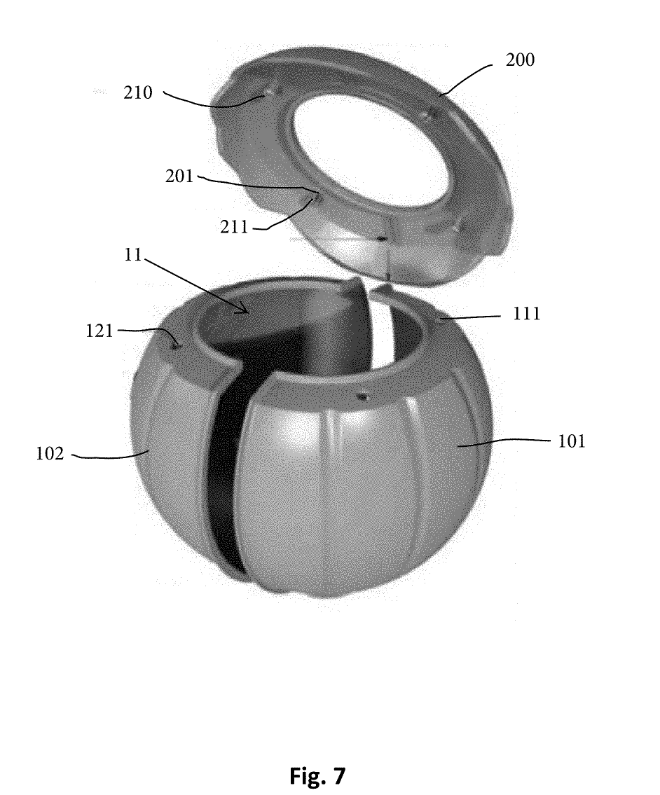

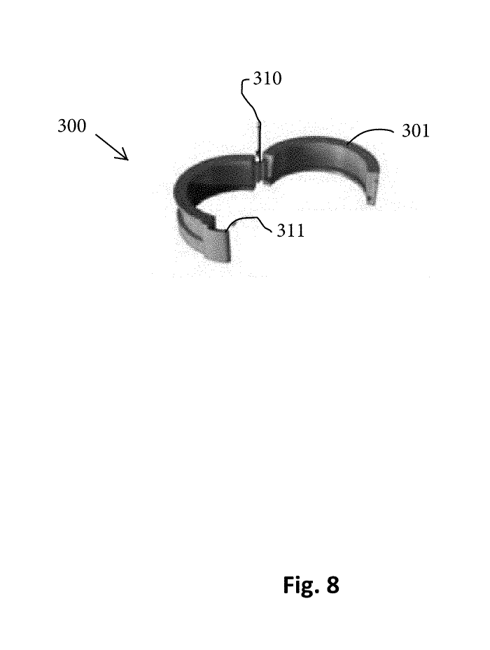

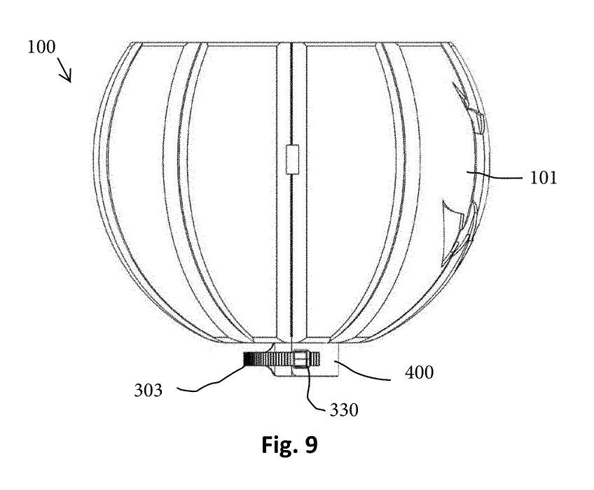

Referring to the figures, FIGS. 1-9 show the decorative lighting solution of the present invention and generally referred to as device 10. The device 10 is designed to be securely affixed to exterior light fixture, such as a landscape or pathway light, to provide an occasional and festive decorative covering that can be easily applied and removed by a user for various holidays and occasions. The device 10 is generally adapted for placement on the stem 1 portion of the lighting fixture for encircling the light element of the fixture. Typically, these light fixtures utilize a standard sized tubular pole or stem 1 having a circumference for generally supporting the fixture and enabling the pass though of the various electrical connections for the light.

The assembled device 10 is comprised generally of a shell portion 100, a top portion 200, a fastener 300, and a gasket member 400. The shell portion 100 defining an interior hollow cavity 11 for receipt of a light portion of the light fixture. The shell 100 is provided in a first half 101 and a second half 102 in a coupled assembly, wherein the first half 101 is generally aligned with and mated to the second half 102 to form the shell portion 100. The shell portion 100 generally adapted to surround the lighting element of a light fixture and comprised of a translucent material to allow for the dispersal of light through the shell 100 for illuminating the shell 100, wherein a user will generally place the halves 101, 102 around the light fixture and secure into place onto the gasket member 400 with the fastener 300. The coupling of the first half 101 and the second half 102 of the shell 100 may be facilitated through the use of cooperative tabs 110 and slots 120, wherein each half 101, 102 includes corresponding tabs 110 and slots 120 to enable proper alignment of the halves 101, 102 and a secure coupling. The tabs 110 and slots 120 ensure that an edge portion of each half 101, 102 of the shell portion 100 are held together initially in the assembly process of the device 10.

The top portion 200 of the assembled device 10 is configured to aid in the securing of the first half 101 and the second half 102 by generally surrounding the perimeter of and affixing to an upper portion of the mated first half 101 and second half 102 of the shell 100. The top portion 200 including a plurality of projections 201 configured for corresponding receipt in a plurality of apertures 111, 121 positioned on the upper portion of the first half 101 and second half 102, wherein the top portion 200 is received upon the shell 100 for securing the mated assembly of the first half 101 and the second half 102. The top portion 200 may be secured through a snap fit assembly, wherein the projections 201 include a head portion 210 having a diameter larger than the diameter of the corresponding aperture 111, 121 and slit 211 generally allowing for movement of the projection 201 to enable the snap fit connection. Alternately, the top portion 200 may include a twist-lock assembly, wherein the projections 201 are generally received within a slot on the upper portion of the halves 101, 102 for locking the top portion 200 into place.

The gasket member 400 is comprised of a resilient and elastomeric material, such as a rubber or rubber-like material, and adapted to provide a secure connection between the shell 100 and light fixture. The gasket member 400 surrounding the circumference of the pole of the light fixture to form a coupling between the shell portion 100 and the gasket member 400. The gasket member 400 including an exterior portion 401 having a channel 410. The channel 410 forming a first shape adapted to correspond to a second shape on an interior surface of the bottom portion of the shell 100, wherein the channel 410 enables a proper coupling and seating of the shell 100 on the gasket member 400 in a desired position.

The gasket member 400 having an interior portion 402 adapted for contact with the pole of the light fixture and including at least one internal rib 420 to aid in this contact and enable positioning of the gasket member 400. The internal rib 420 designed to prevent slippage of the gasket member 400 and ensure a secure coupling with the pole.

In the preferred embodiment, the gasket member 400 is comprised of a pair of halves that are assembled onto the pole at a desired position. Accordingly, the gasket member 400 will have a first half and second half assembled together to surround the pole in an assembly. The first half and the second half of the gasket member 400 may include various locational pockets 403 and ribs 430 to ensure proper alignment and assembly and be secured together though a fastener 404, such as a self-tapping screw.

In an alternate embodiment, the gasket member 400 can be integrated directly into the bottom portion of the shell 100 though an overmolding process, wherein the gasket member 400 aids in securing the shell 100 to an existing light pole.

The securing fastener 300 functioning as a means to secure a bottom portion of the shell 100 around the gasket member 400 and to the light fixture. The fastener 300 preferably being a locking clip 301 having a hinge 310 and clasp 311 and having a size corresponding to a size of the lower portion of the shell 100 for generally surrounding the lower portion with a grasping force. The locking clip 301 adapted to be easily installed and removed from the assembly of the device 10.

In an alternate embodiment of the present invention, the fastener 300 may be a zip tie 302 or zip tie like device adapted to surround the lower portion of the shell and exerting a grasping and squeezing force to the assembly between the shell portion 100 and the gasket member 400. Preferably this zip tie 302 is adapted for reuse.

Alternately the securing fastener 300 is a flexible strap member 303 received within a buckle 330 and designed to wrap or otherwise encircle the stem portion of the lighting fixture on an exterior of the shell portion 100.

The device 10 of the present disclosure is generally depicted as a as a pumpkin, but the shell portion 100 can be formed in a multitude of shapes and designs corresponding to various holidays and festivities while still maintaining the general features and attachment means of the device 10.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An assembly for surrounding a light element of a light fixture, the assembly comprising:
a shell portion, the shell portion defining a cavity for receipt of the light element;
a gasket member, the gasket member positioned between the shell portion and the light fixture; and
a fastener, the fastener positioned on the shell portion and configured to secure the shell portion to the gasket member and light fixture.

2. An assembly as in claim 1, wherein the assembly comprises a top portion, the top portion affixed to an upper portion of the shell portion.

3. An assembly as in claim 2, wherein the fastener is a clip.

4. An assembly as in claim 2, wherein the fastener is a zip tie.

5. An assembly as in claim 1, wherein the shell portion is comprised of a first half and a second half.

6. An assembly as in claim 1, wherein the shell portion is translucent.

7. A device for attachment to an existing exterior lighting fixture, the device adapted with various designs selected for holidays and festive occasions, the device comprising:
a shell portion, the shell portion being translucent and configured to surround a light element of the lighting fixture, the shell portion comprising:
a first half; and
a second half;
a gasket member, the gasket member being resilient and received upon the lighting fixture between the shell portion;
a top portion, the top portion secured to an upper portion of the shell portion and surrounding the shell portion for securing the first half and the second half; and
a fastener, the fastener placed on the shell portion and configured to provide a grasping force to an exterior of the shell portion for securing the shell portion to the light fixture.

8. A device as in claim 7, wherein the fastener is a clip.

9. A device as in claim 7, wherein the fastener is a zip tie.

10. A device as in claim 7, wherein the shell portion upper portion includes a plurality of apertures and the top portion includes a plurality of projections, the plurality of projections sized for receipt within the plurality of apertures, wherein the top portion is configured to snap into the upper portion of the shell portion.

11. A device as in claim 7, wherein the gasket member includes an exterior surface, the exterior surface having a channel, wherein the shell portion is configured for receipt in the channel.

12. A device as in claim 11, wherein the gasket member includes an interior surface, the interior surface having at least one rib.

13. A device as in claim 8, wherein the clip includes a hinge and a clasp.

14. A device as in claim 7, wherein the gasket is integral with the shell portion.

15. A device configured for attachment to an existing exterior lighting fixture, the device having various designs selected for holidays and festive occasions, the device comprising:
a shell portion, the shell portion being translucent and configured to surround a light element of the lighting fixture, the shell portion comprising:
a first half having a first upper portion and first lower portion; and
a second half having a second upper portion and a second lower portion;
a gasket member, the gasket member being resilient and received upon the lighting fixture between the first lower portion and the second lower portion;
a top portion, the top portion having a plurality of projections and secured to the first upper portion of the shell and the second upper portion of the shell portion and surrounding the first half and the second half of the shell portion for securing the first half and the second half; and
a means for securing the first bottom portion and the second portion to the light fixture.

16. A device as in claim 15, wherein the securing means is a clip.

17. A device as in claim 15, wherein the securing means is a zip tie.

18. A device as in claim 15, wherein the first upper portion and second upper portion includes a plurality of apertures sized to receive the projections of the top portion, wherein the top portion is configured to snap into the upper portion of the shell portion.

19. A device as in claim 15, wherein the gasket is integral with the shell portion.
